(19) United States
(12) Patent Application Publication
(10) Pub. No.: US 2022/0248654 A1
(43) Pub. Date: Aug. 11, 2022

(54) INSECT TRAP ASSEMBLY AND METHOD OF USE

(71) Applicant: Stratex Partners LLC, Scituate, MA (US)

(72) Inventors: Robert Howland, Scituate, MA (US); Qian Hai, Shenzhen (CN); Jian Ming Li, Zhongshan (CN)

(21) Appl. No.: 17/667,496

(22) Filed: Feb. 8, 2022

Related U.S. Application Data
(60) Provisional application No. 63/147,186, filed on Feb. 8, 2021.

(51) Int. Cl. A01M 1/02

(52) U.S. Cl. CPC A01M 1/023

(57) ABSTRACT

An apparatus and associated method of use is described for attracting and trapping mosquitos and other biting insects using a vapor cloud of atomized carbon dioxide (CO2) gas as an insect attractant. The apparatus also employs other insect attractants as adjunct attractants to the vapor cloud of atomized carbon dioxide (CO2) gas. In an embodiment, atomized water vapor is generated to be combined with 2 chemical ingredients to create the atomized vapor cloud of carbon dioxide (CO₂) which is dispersed into the interior of the device to maintain a level above 2000 parts per million (ppm).

### RELATED APPLICATIONS

This application claims priority to U.S. Provisional Application Ser. No. 63/147,186, entitled “INSECT TRAP ASSEMBLY AND METHOD OF USE” filed on Feb. 8, 2021, the disclosure of which is hereby incorporated by reference in its entirety.

### TECHNICAL FIELD

This disclosure relates generally to methods and apparatus for attracting and trapping mosquitos and other biting insects, and in particular to an apparatus that includes a carbon dioxide (CO2) generator that creates an atomized vapor cloud of CO2 gas for use as an insect attractant.

### BACKGROUND

Flying insect pests have long been a nuisance and a health hazard and have plagued people throughout time. In addition to the itching and resulting infections of their bites, mosquitoes carry diseases such as malaria, yellow fever, dengue fever, encephalitis. Millions of people worldwide die from mosquito-borne diseases every year. Not only can mosquitoes carry diseases that afflict humans, they can also transmit several parasites and diseases that dogs and horses are very susceptible to getting. Such diseases may include, for example, filarial diseases including dog heartworm, West Nile virus (WNV) and Eastern equine encephalitis (EEE). Other mosquito vectored diseases include protozoan diseases, i.e., malaria and viruses such as dengue, encephalitis, and yellow fever. In addition, mosquito bites can cause severe skin irritation through an allergic reaction to the mosquito's saliva—this is what causes the red bump and itching that many people experience when bitten.

Various methods and devices have been proposed for killing or reducing the population of mosquitos or at least to prevent them from bothering the human population with their presence. To attract, repel, or trap assembly arthropods such as insects, mosquitoes, chiggers, flies, fleas, and ticks, systems typically take advantage of their specific behaviors of search, locate, or avoidance. Mosquitoes in particular have a sophisticated array of means and behavior to locate their prey and avoid hazards. Mosquitoes can detect distant carbon dioxide emissions and moisture. Over 50 chemicals, such as octenol, and lactic acid, have been identified as attractants to mosquitoes and presumably have been used as chemical signatures of their prey. For example, U.S. Pat. No. 4,818,526 to Wilson discloses the use of dimethyl disulfide and dibutyl succinate and combinations thereof as attractants for Culicidae (mosquitoes).

A well-known method for the suppression of mosquito populations is the use of chemical pesticides, such as DDT and Malathion. There are basically two types of pesticides for mosquitoes available adulticides or adult exterminators, and larvicides or larval exterminators. Adult exterminators are chemicals that are used to kill mosquitoes that have already developed to reach adult. Infested areas of adults are sprayed primarily from aircraft or motor vehicles. The effectiveness of the sprayed chemicals typically depends on the wind, temperature, humidity and time of day, the resistance to the chemical used of the mosquito in question, and the basic effectiveness of the particular chemical. Adult exterminators must be applied for each generation of adults generated by rain, tidal-floods or other periodic triggers of egg incubation and have a typical window or margin of effectiveness of only ½ day. As such, these chemicals must be applied at a time when maximum contact with adult mosquitoes can be expected.

Regardless of the effectiveness of chemicals, or supposed or lack thereof, the use of chemical pesticides has drastically reduced both in the United States and in the world. A fundamental reason for this reduction may be attributed to the growing public awareness of possible health risks related to the use of pesticides. Specifically, the perception of the general public of long-term health risks of certain products. Chemicals, such as DDT, have led to the ban on their use for mosquito control in many states and other countries. Additionally, the growing pesticide resistance among mosquitoes reduces the effectiveness of chemicals conventionally used, thus reinforcing the argument that the supposed benefits of chemical pesticides do not compensate for potential health risks.

Natural predators also control in some measure mosquito populations. For example, certain fish and dragonflies (both in nymphs as adults) are predators of both larval and mosquito adults. Certain bats and birds also prey on mosquitoes. Reliance on natural predators as an environmentally safe way to control populations of mosquitoes has also been attempted. Unfortunately, efforts made in the past to use natural predators to control mosquito populations have largely been ineffective. For example, large bat towers were erected in three southern cities during the 1920s with the expectations that the bats that inhabited the towers would control the mosquito population. However, the towers turned out ineffective for the adequate control of local populations of mosquitoes. Studies of the stomach contents of the bats discovered that mosquitoes constituted less than 1% of their source food.

Today many people rely on repellents to keep mosquitoes away from their person, or from a certain area, for example when eating outside. These repellents, by their nature, do nothing to control the mosquito population and, at best, offer temporary relief in the vicinity where the repellant is used. Repellents can be either topical or aerial, for application through the air, and can take many shapes, including lotions, sprays, oils (for example, the “Skin-So-Soft”), and candles (for example, “citronella”), among others. The most common repellents (lotions, sprays, and oils) are those that are used on clothes or the body. Many of these repellents do not really “repel” mosquitoes by themselves, instead they simply mask the factors (carbon dioxide, moisture, body heat and acid lactic) that attract a mosquito to its host.

Repellents can be expensive, often have a smell that may be unpleasant, and are only effective for a limited duration. It has also been found that repellents containing DEET, or ethyl hexanediol, become attractive to mosquitoes after a certain period of time. Consequently, it is recommended, when using repellents to remove them by washing, or to reapply fresh repellent after the period of protection has passed. In addition to having an unpleasant smell, many repellents are being closely monitored regarding the possibility of long-term risks they may pose. DEET is considered by many entomologists as the best repellent available, has been marketed for more than 30 years, and is the basic ingredient in many sprays and well-known lotions. Although the US Environmental Protection Agency (“EPA”) believes that the normal use of DEET does not present a health concern to the general population, including children, there remains a segment of the population that could be sensitive to repeated applications of DEET. A 2018 Consumer Reports nationally representative survey of 2,052 adults found that 25 percent of Americans said they avoid using insect repellents with DEET, confirming that concerns over the safety of DEET remains despite continued assurances by the EPA that it is safe.

In an attempt to repel mosquitoes from outdoor gatherings, many people have turned to the benefits of citronella, either in the form of candles, plants, incense, or other dispersal mechanisms. According to some studies, products with citronella as a base material are only slightly effective in repelling mosquitoes, and only when multiple candles are placed about every 3 feet around a protected area. According to one study, the use of citronella candles was only slightly more effective than simply burning candles around the protected area. Some research indicates that the burning of candles increases the amount of carbon dioxide in the air, which can increase the number of mosquitoes attracted to the protected area. Despite the lack of effectiveness, the current market for products with citronella base material remains quite large.

In addition to the foregoing, electrocution devices, first introduced in the late 70s, having a black light and sold as “insect suppressors,” were initially a commercial success. While they have been shown to be ineffective to kill mosquitoes, insect suppressors are sold currently at a rate of more than 2,000,000 units per year. The inability of these devices to kill mosquitoes has demonstrated in both academic studies and personal experience of many owners of insect suppressors. The electrocution devices do not kill mosquitoes because they don't attract most types of mosquitoes. Instead, these devices only attract insects that are attracted to light, which is not the case with most types of mosquitoes.

U.S. Pat. No. 6,145,243 describes an insect trapping device that generates its own insect attractants of carbon dioxide (CO₂), heat and water vapor through catalytic conversion of a hydrocarbon fuel in a combustion chamber to attract mosquitoes and other flying insects towards an entrance opening in the device. The device includes a vacuum that sucks the insects attracted by carbon dioxide through the entrance and traps the insects inside. The insect trapping device also includes a disposable mesh bag attached to the vacuum where mosquitoes are dehydrated are held. The trap may be adapted for trapping different types of insects by adjusting airflow velocities and attractants.

U.S. Pat. No. 9,326,397 describes an insect trapping device that can utilize multiple methodologies to lure and trap insects into a trap housing. The device includes (1) a solar panel roof to supply power to the power consuming features of the trap; (2) one or more insect attractants; (3) a fan mechanism to pull insects and direct them toward the trap; and (4) a secure retention mechanism that prevents escape of captured insects. A key feature of the device, as disclosed in the patent, is the use of a suction vacuum in conjunction with multiple non-chemical attractants in lieu of using pesticides or other harmful chemicals.

Although carbon dioxide has been known to be used as an attractant, methods of carbon dioxide dispersion have been less commercially viable. Carbon dioxide gas used as an attractant is typically provided by pressurized propane tanks or by the sublimation of dry ice. The use of propane tanks and dry ice is cumbersome as both are heavy and occupy a great deal of space. This results in devices that are often too large to truly be portable and, thus not commercially viable for individuals.

### SUMMARY

The present disclosure describes an insect luring and trapping device and associated method which generates an atomized carbon dioxide (CO₂) vapor cloud as one attractant to attract mosquitos and other flying insects towards an entrance opening arranged in the device. The device is lightweight, compact, and efficient in the production and dispersion of CO₂, and effectively attracts and kills mosquitos, even while having a small footprint.

The insect trapping device in one embodiment includes a housing, an atomizer, a fan and an ultraviolet light. The device provides a lightweight and portable insect trap assembly without the need for a propane tank. The insect trapping device is capable of operating continuously for about one month, generating a vapor cloud of atomized carbon dioxide (CO₂) at a level above 2000 parts per million (ppm). The insect trapping device periodically generates its own vapor cloud of atomized carbon dioxide (CO₂) through an atomization process including two chemicals stored within the ultrasonic atomizer unit in an isolated pre-mixed state. The two chemicals are periodically mixed and then aerosolized by an atomized stream of water stored internally to create the vapor cloud of atomized carbon dioxide (CO₂). The two preferred chemicals include aluminum sulfate Al₂(SO₄)₃ and sodium bicarbonate NaHCO₃. The aluminum sulfate is selected as a first preferred chemical by virtue of having the property of being a solid at room temperature that can readily generate carbon dioxide (CO₂) after hydrolysis. The sodium bicarbonate is selected as the second preferred chemical to be chemically combined with the aluminum sulfate on the basis of having the property of being comprised of solid molecules that are active and that can generate carbon dioxide (CO₂) easily. Once the vapor cloud is created it exits the insect trapping device through the housing, for example through openings therein.

Other attractants used in concert with the vapor cloud of atomized carbon dioxide (CO₂) may include an ultraviolet light source and a source of octenol. It is contemplated that other operational features may be located within the body of the housing as well in order to attract and store insects.

In one exemplary embodiment, the insect trap assembly has a body which is generally cylindrical in shape and utilizes the insect attractants discussed above. The cylindrically shaped body may be constructed so that a vacuum airflow is created, as described in greater detail below.

In one exemplary embodiment, a carbon dioxide (CO₂) generator, referred to herein as a (CO₂) ultrasonic vibration atomizer, is configured to generate an atomized cloud of (CO₂) gas at set intervals. The atomized cloud of (CO₂) gas is released within the device by a process of that utilizes a water source stored within the housing, for example in a water tank, in combination with the ultrasonic vibration atomizer to create water vapor. The atomized water vapor is transported into a reaction chamber containing a mixture of predefined amounts of the two chemicals (aluminum sulfate and sodium bicarbonate), for example by traveling through a connection tube into the reaction chamber. The two chemicals react with the entering atomized water vapor to create an atomized cloud of (CO₂) gas at ambient temperature as one attractant. The CO₂ ultrasonic vibration atomizer may be supported within one end of the device, for example the top of the insect trapping device.

Supported within the housing is the second of three possible attractants, namely, an ultraviolet light, or “black light” for example a purple light tube. The light may be configured and arranged to illuminate the mosquitos with a light wavelength of around 365 nm to 400 nm to further lure the mosquitos towards the device as an additional attractant to the atomized cloud of (CO₂) gas. The light is supported by the housing and may be located centrally, below the (CO₂) ultrasonic vibration atomizer.

The third attractant contemplated for use is a source of octenol, which is well known to those skilled in the art.

In one aspect, a fan is supported within the housing, for example at a bottom portion thereof, the fan being arranged to move the mosquitos along an airflow which draws down the mosquitos into the bottom of the device past the atomized cloud of (CO₂) gas (i.e., first attractant) and ultraviolet light (i.e., second attractant) into a capture basket to eventually die of dehydration once captured. The capture basket is removably attached to the bottom of the body and may lock in place. The capture basket may be cylindrical in shape and is includes an open top portion and a closed bottom portion. The sidewalls of the basket may be lined with a mesh material as to allow airflow but prevent passage of insects through the sidewalls of the basket once trapped.

It will be appreciated by those of skill in the art that the device is easy to install, and convenient to use. The present disclosure contemplates a device that is made of durable yet lightweight materials (e.g., plastic or metal) that can be easily carried by the user and then placed or hung in an indoor or outdoor environment. The device is also preferably constructed and packaged so that it does not require assembly by the user.

In at least one aspect, the device is used for outdoor use and provides protection of the operating components of the device from the natural elements.

According to one exemplary embodiment disclosed herein, in a method for making an atomized cloud of (CO₂) gas, the method includes the steps of: providing a first storage cup “A” having sodium bicarbonate disposed therein, providing a second storage cup “B” having aluminum sulfate disposed therein, providing a separator between storage cup “A” and storage cup “B” to keep the chemicals separated prior to mixing, providing a water tank to store water, providing a source of mechanical vibration constructed and arranged to create an ultrasonic wave directed at the water in the water storage tank to create a fine mist of water droplets, i.e. an atomization spray, which is sprayed upon mixing the sodium bicarbonate in storage cup “A” with the aluminum sulfate in storage cup “B,” to create the vapor cloud of atomized carbon dioxide

### BRIEF DESCRIPTION OF THE DRAWINGS

Various aspects of at least one embodiment are discussed below with reference to the accompanying figures, which are not necessarily drawn to scale, emphasis instead being placed upon illustrating the principles disclosed herein. The figures are included to provide an illustration and a further understanding of the various aspects and embodiments and are incorporated in and constitute a part of this specification but are not intended as a definition of the limits of any particular embodiment. The figures, together with the remainder of the specification, serve only to explain principles and operations of the described and claimed aspects and embodiments, but are not to be construed as limiting embodiments. In the figures, each identical or nearly identical component that is illustrated in various figures is represented by a like numeral. For purposes of clarity, not every component may be labeled in every figure.

FIG. 1 is a front view of an insect trap assembly device according to one embodiment of the present disclosure;

FIG. 2 is a top-level exploded view of the insect trap assembly device of FIG. 1;

FIG. 3 is an exploded view of a CO2 ultrasonic vibration atomizer;

FIG. 4 is a structural operational flow diagram of the device of FIG. 1;

FIG. 5 is a top-level flowchart illustrating a method of operation of the device of FIG. 1;

FIGS. 6-7 are device design flowcharts of the device of FIG. 1;

FIGS. 8-11 are perspective views of the CO2 ultrasonic vibration atomizer;

FIGS. 12-14 are perspective views of the CO2 cartridge assembly;

FIG. 15 is a flowchart illustrating a method for preparing the CO2 cartridge for use;

FIG. 16 is an illustration of an LED indicator for reminding a user to refill the water tank and change the CO2 cartridge of the CO2 ultrasonic vibration atomizer;

FIG. 17 is an illustration of a method for replacing the UV bulb;

FIG. 18 is an illustration of a method for hanging the lure clip on the device; and

FIG. 19 is an illustration of a method for emptying the trash plate.

### DETAILED DESCRIPTION OF THE ILLUSTRATIVE EMBODIMENTS

The examples of the apparatus discussed herein are not limited in application to the details of construction and the arrangement of components set forth in the following description or illustrated in the accompanying drawings. It will be understood to one of skill in the art that the apparatus is capable of implementation in other embodiments and of being practiced or carried out in various ways. Examples of specific embodiments are provided herein for illustrative purposes only and are not intended to be limiting. Also, the phraseology and terminology used herein is for the purpose of description and should not be regarded as limiting. Any references to examples, embodiments, components, elements or acts of the apparatus herein referred to in the singular may also embrace embodiments including a plurality, and any references in plural to any embodiment, component, element or act herein may also embrace embodiments including only a singularity (or unitary structure). References in the singular or plural form are not intended to limit the presently disclosed apparatus, its components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

### Device Overview

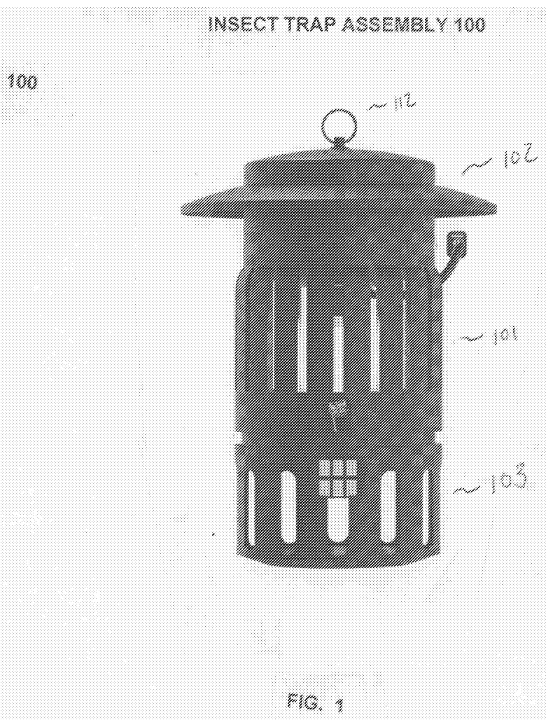

FIG. 1 shows an insect trap assembly 100 according to an embodiment of the present disclosure. Insect trap assembly 100 includes a housing having a body 101 and a lid 102 that may generally overlie the body 101, which may be generally cylindrical in shape having a grid like structure. In the present embodiment, a trap or capture basket 103 that is supported by the body 101 is constructed to retain insects and is removable from the body 101 for emptying. Lid 102 may be generally circular with a top surface that may include a hanging member 112, for example a hook, for hanging the insect trap assembly from a tree or other structure. It is appreciated that top lid 101 may be defined by other styles of roofing and that the housing is not limited to the geometric configuration shown herein. The housing components may be made of any acceptable material, including for example plastic.

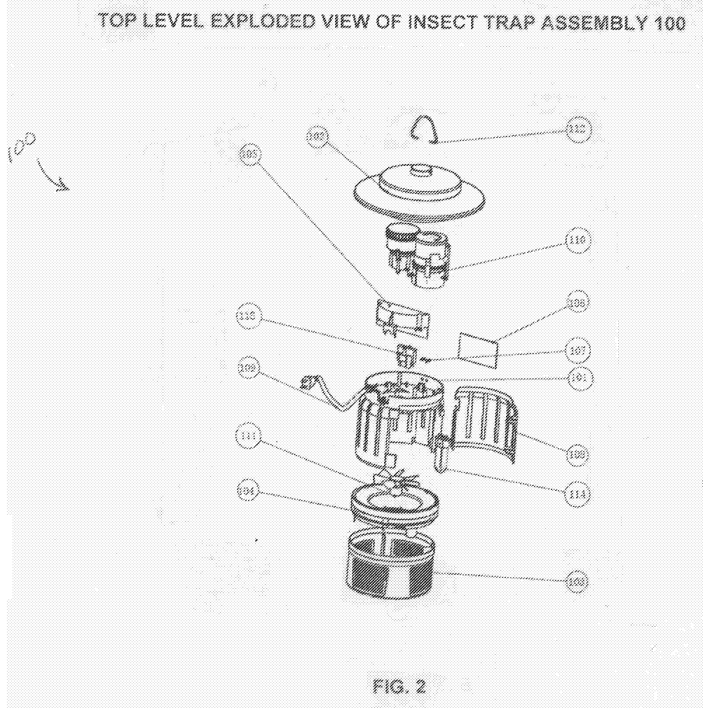

FIG. 2 is an exploded view of the insect trap assembly 100 of FIG. 1. In the embodiment shown in FIG. 2 the insect trap assembly 100 comprises:

TABLE I
(Insect Trap Assembly - Top Level)

| | Item | Function |
|---|---|---|
| 101 | Housing Body | Insect trap assembly |
| | | housing and grid |
| 102 | Top Lid | Overlies the housing body |
| 103 | Capture Basket | Repository for dead |
| | | and dying flies and |
| | | mosquitos drawn down |
| | | into the device by the fan |
| 104 | Fan Holder | Secures Fan 111 to Housing |
| 105 | Circuit Board | Protects Circuit Board |
| | Waterproof Box | |
| 106 | Circuit Board | Components to control |
| | | timing of device |
| 107 | LED indicator | Remind user to fill water tank |
| | | and change CO2 cartridge |
| 108 | Movable Gate | Part of Housing, allows access |
| | | to interior of housing |
| 109 | UL Power Cord | Supply external power |
| 110 | CO2 Ultrasonic | Creates atomized vapor |
| | atomizer unit | cloud of CO2 |
| 111 | Fan | Draws mosquitos down |
| | | into capture basket 103 |
| 112 | Hook/Hanging | Hang insect trap device |
| | element | from the hook |
| 113 | UV Bulb Holder | Holds UV bulb |
| 114 | UV bulb, “black light” | Generates UV light |
| | | as one attractant |

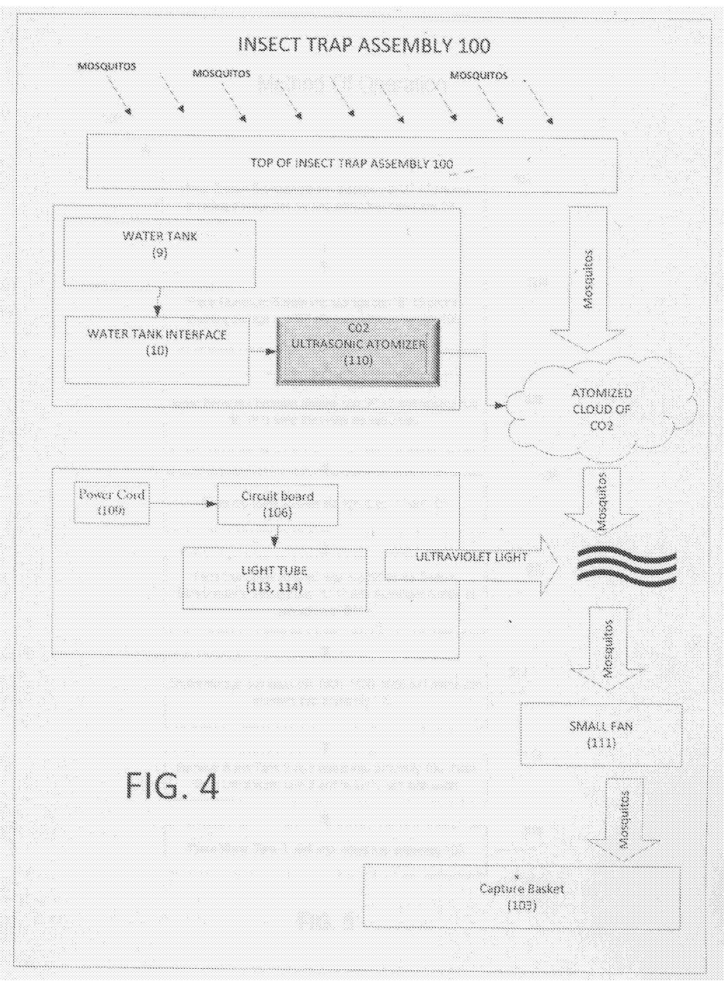

FIG. 4 is a structural operation flow diagram that illustrates operational features of the insect trap assembly 100 according to one embodiment. Insects attracted to the insect trap assembly 100 are drawn into the trap through a plurality of gaps between posts in the housing body 101 and enter a space between the top lid 102 and the housing body 101 in order to pass to the interior of the housing body 101. The insects pass certain operational features disposed in the interior of the housing and exit the housing body 101 by passing downward into the attached capture basket 103.

The insect trap assembly utilizes an ultrasonic vibration atomizer 110 to periodically generate an atomized vapor cloud of carbon dioxide (CO₂), which is released into the interior of the housing body 101 to attract insects (first attractant), for example mosquitos and other biting insects. Additional insect attractants for attracting and trapping mosquitos and other biting insects may be utilized with the atomized vapor cloud, such as octenal and an ultraviolet light assembly.

### Light Attractant

Referring to FIGS. 2 and 4, disposed centrally in the insect trap body 101 there is arranged a second attractant comprising a light tube assembly including a bulb holder 113, and light bulb 114 constructed and arranged to illuminate the insects/mosquitos with a wavelength of about 365 nm to 400 nm. In the present embodiment, the light tube assembly 113, 114 is mounted to the body 101 by fasteners, for example mounting brackets and attachment members such as bolts or screws. It is appreciated that there are alternative ways to mount light tube assembly 113, 114 within the body 101 as would be known to those of skill in the art. Light tube assembly 113, 114 is attached to a power source, preferably an AC power supply that is externally provided. An on-off switch (not shown) may also be provided and assume either of two positions and accordingly make or break connections in a circuit to supply or terminate power to light bulb 114, as would be known to those of skill in the art.

### Octenal Attractant

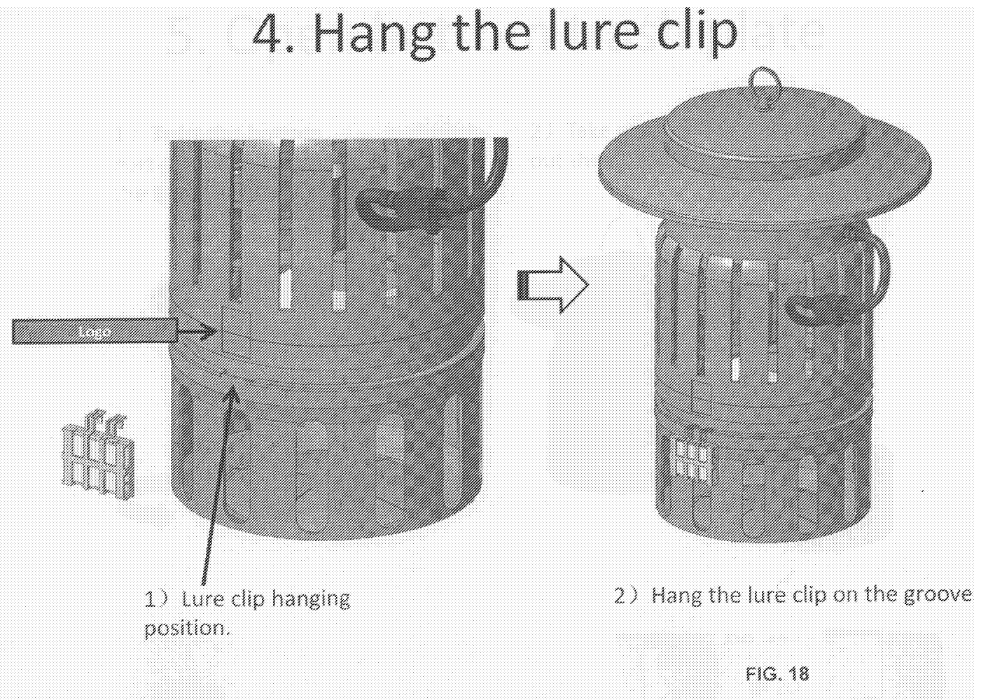

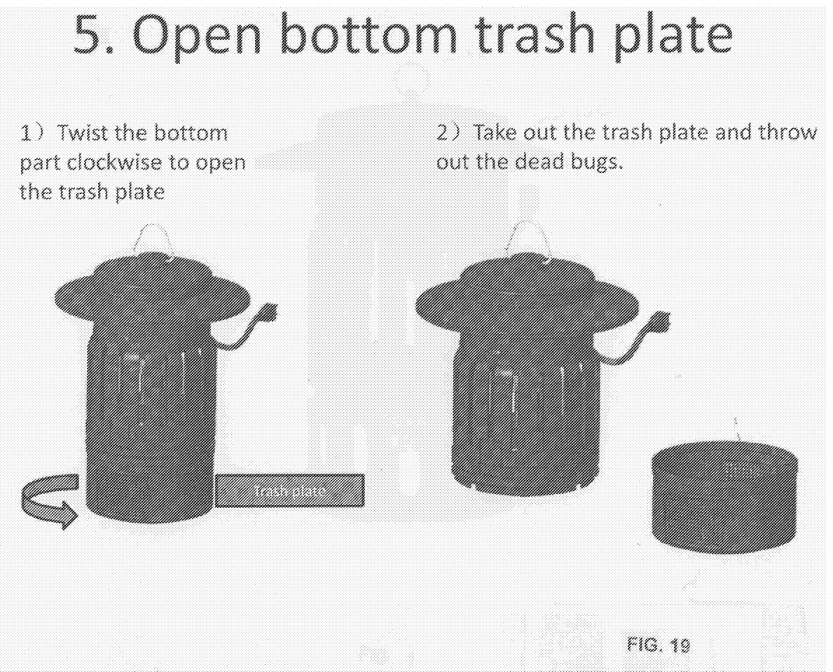

As shown in FIG. 1, a third attractant comprises a source of octenol that is preferably placed in a plastic clip that may hang from the housing adjacent the capture basket 103 and/or the body 101. The plastic lure clip is best shown in FIG. 18. Notably, octenal is a chemical that has been used in combination with CO₂ to attract mosquitos with varying results. While disclosed herein as additional possible attractants, octenal and the light source may or may not be utilized with the CO₂ cloud.

### CO₂ Cloud Attractant

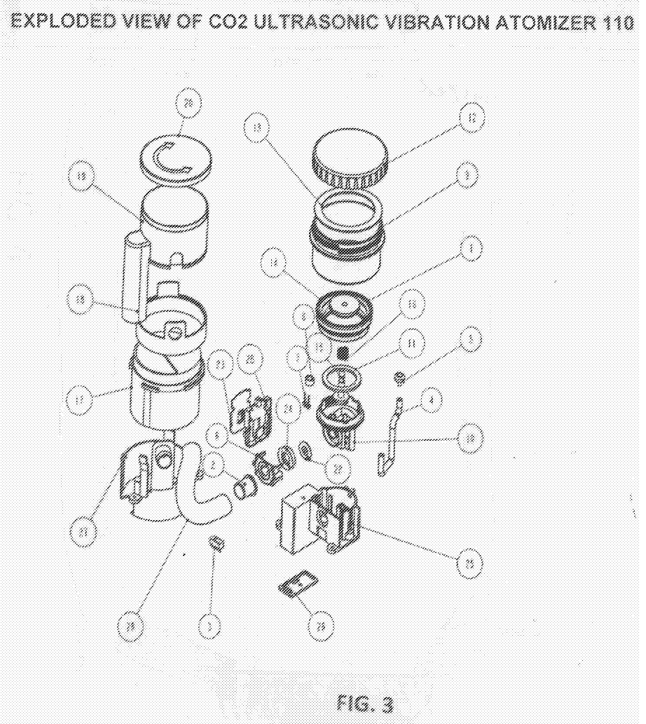

Referring to FIG. 3, there is shown an exploded view of the carbon dioxide (CO₂) ultrasonic vibration atomizer 110 shown in FIG. 2. The carbon dioxide (CO₂) ultrasonic vibration atomizer 110 is configured and arranged to periodically generate an atomized vapor cloud of carbon dioxide (CO₂) which is released into the interior of the housing 101 at a level above 2000 parts per million (ppm) periodically for up to 30 days as the first attractant. In the present exemplary embodiment, the CO₂ ultrasonic vibration atomizer 110 is supported on an upper interior portion of the insect trap assembly 100 proximal the top lid 101. The CO₂ ultrasonic vibration atomizer 110 is configured and arranged to generate an atomized vapor cloud of CO₂ periodically, for example approximately once every 24 hours, for a duration of approximately 15 seconds. The CO₂ ultrasonic vibration atomizer 110 is also configured and arranged to detect the quantity of water remaining in the water tank 9. When an insufficient quantity of water is detected in the water tank 9, the indicator light (LED 9) will automatically light up and prompt a user to add more water.

With continued reference to FIG. 2, the component list of the Ultrasonic Vibration Atomizer includes the following components:

TABLE II
(components of Ultrasonic Vibration Atomizer 110)

| | Item Description | Function |
|---|---|---|
| 1 | Telescopic waterproof Ring | Seal |
| 2 | Nozzle | Sprays Water |
| 3 | Micro Switch | On/Off |
| 4 | Exhaust Silicone Tube | Balances water pressure |
| 5 | Exhaust Pipe plug | Top of Exhaust Silicone Tube |
| 6 | Probe holder | Holds Probe in place |
| 7 | Probe | Detects if water available |
| 8 | Waterproof Ring | Seals |
| | of Probe | |
| 9 | Water Tank | Holds Water |
| 10 | Interface of Water Tank | Base of Water Tank |
| 11 | Interface with | Holds Water Proof |
| | Waterproof Ring | Ring in place |
| 12 | Water Tank Lid | Covers water tank |
| 13 | Waterproof Ring | Seals |
| | of Water Tank | |
| 14 | Water Valve | Allows water to flow |
| 15 | Tie Rod of Water Valve | Part of water valve |
| 16 | Tie Rod Spring | Part of water valve |
| | of Water Valve | |
| 17 | Storage Cup A | Holds first chemical |
| 18 | Connector of Storage | Connects storage cup “A” |
| | Cup A and Cup B | to storage cup “B” |
| 19 | Storage Cup B and | Holds second chemical and |
| | CO2 Exhaust | provides a means to exhaust |
| | | atomized CO2 vapor cloud |
| 20 | Lid of Storage Cup B | Covers Storage Cup B |
| 21 | Separator | Keeps first chemical separated |
| | | from second chemical until user |
| | | mixes them mechanically |
| 22 | Ultrasonic Vibration | Atomizes water |
| | Slice | into water vapor |
| 23 | Ultrasonic Probe PCB | Senses if water present |
| 24 | Waterproof Ring of | Seal |
| | Ultrasonic Probe PCB | |
| 25 | Atomizer Shell | Base of Atomizer |
| 26 | Atomizer Bottom Lid | Base of Atomizer |
| 27 | Overall Bracket of Atomizer | Support for Atomizer |
| 28 | Circuit Board Fixing | Holds PCB |
| | Seat of Atomizer | |
| 29 | Connection Silicone | Tranfers water vapor |
| | Tube of Atomizer | into Storage Cup B |

In use, after starting the insect trap assembly 100, the CO₂ ultrasonic vibration atomizer 110 will provide a consistency of the atomized vapor cloud of CO₂ at a level above 2000 parts per million (ppm) for 30 days, as stated above. This amount of CO₂ is substantially four times (4×) the amount of CO₂ found in the air. Notably, other cycle times and durations are within contemplation of the invention to achieve levels of CO₂ above and below the stated 2000 parts per million (ppm) for 30 days.

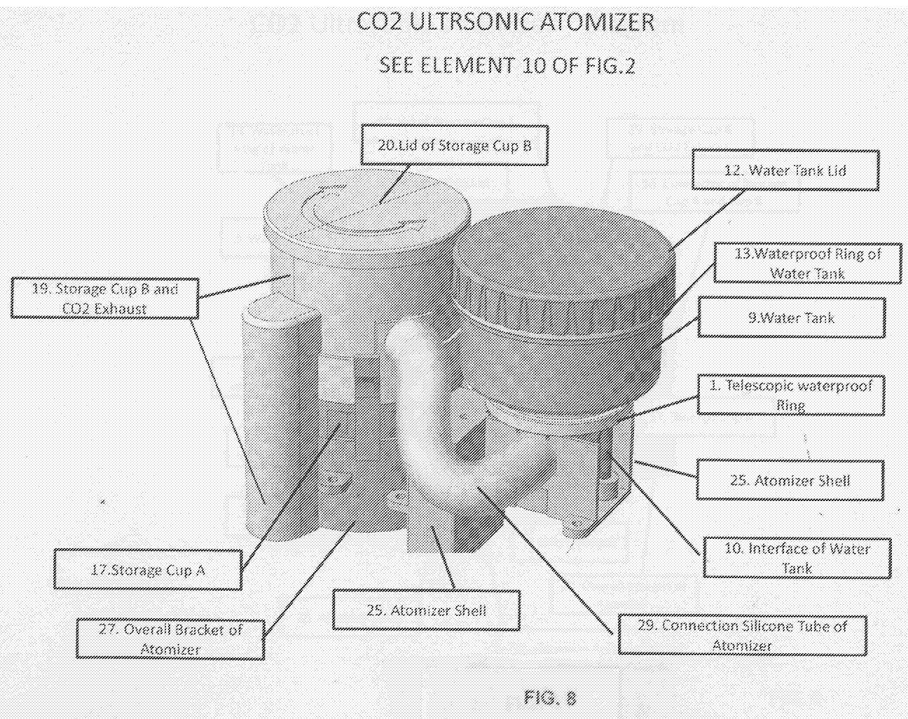

FIGS. 8-11 illustrate various views of the CO₂ ultrasonic vibration atomizer 110. FIG. 8 is a perspective front view of the CO₂ ultrasonic vibration atomizer 110. The front view illustrates that the device is generally comprised of a central portion, a left-hand portion, and a right-hand portion. The left-hand portion comprises the storage cup assembly including storage cup “A” 17, storage cup “B” 19 along with CO2 exhaust. The right-hand portion comprises the water tank 9 and components that support the water tank 9 including the water tank lid 12, the waterproof ring, i.e, seal 13, the telescopic waterproof ring 1 and the water tank interface 10. The central portion comprises those components associated with atomizing the water in the water tank 9 to be fed into storage cup “B” 19 (i.e., the combustion chamber) to generate the atomized vapor cloud of carbon dioxide (CO₂).

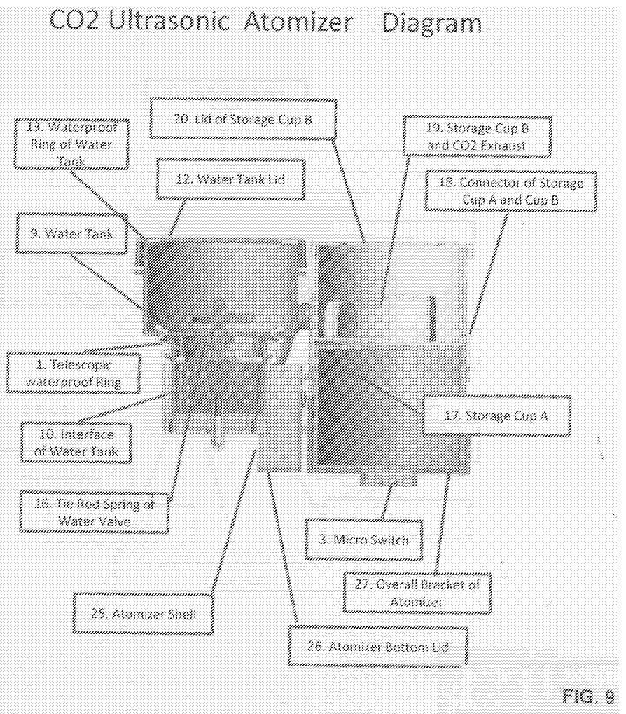

FIG. 9 is a perspective rear view of the (CO₂) ultrasonic vibration atomizer 110 in cross-section cutaway. The rear view best illustrates certain elements of the ultrasonic vibration atomizer 110 not clearly shown in FIG. 8. For example, FIG. 9 illustrates micro-switch 3 which controls timing of the atomizer 110, resetting every 24 hours, and the atomizer shell 25 which acts as a housing to support and protect the ultrasonic atomizer components. Each time the micro-switch 3 is triggered, an ultrasonic wave is created by the mechanical vibration, the wave being directed towards the water in the water storage tank 9 for creating a fine mist of water droplets, i.e. atomization spraying. At the same time, a calculation or countdown begins for the spraying time and the effective service time of the mixture of sodium bicarbonate and aluminum sulfate. After 720 hours, an indicator light (LED 107) is triggered to light up light up, indicating that the mixture of sodium bicarbonate and aluminum sulfate needs to be replace.

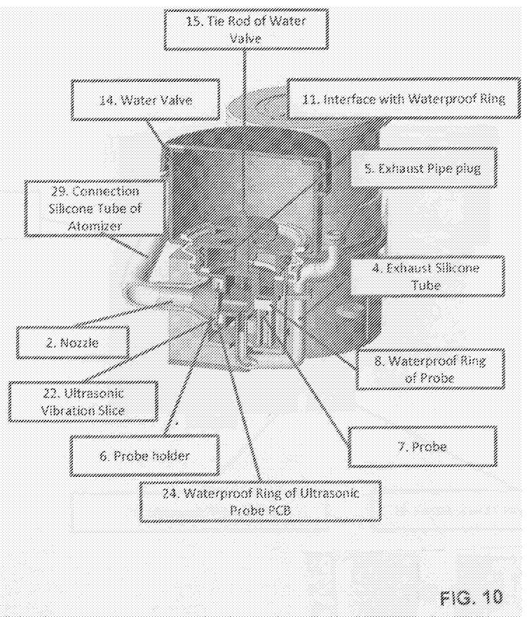

FIG. 10 is a cross-sectional cut-away perspective rear view of the (CO₂) ultrasonic vibration atomizer 110. The cut-away view best illustrates certain elements of the atomizer 110 not clearly shown in FIG. 8 or 9. For example, FIG. 10 illustrates probe 7, which detects if water is available to atomize and ultrasonic vibration slice 22, which atomizes water converting it into water vapor. As is well known to those skilled in the art, the ultrasonic vibration slice 22 operates at a high-frequency oscillation (e.g., 2.4 MHz) whereby liquid water molecules are processed into a flowing mist which results in the release of a large amount of negative ions which reacts with smoke, dust particles and the like floating in the air to cause precipitation.

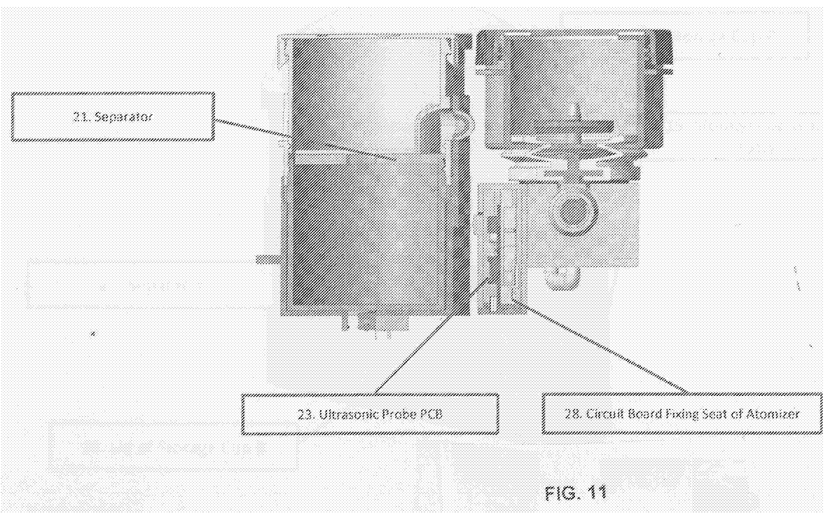

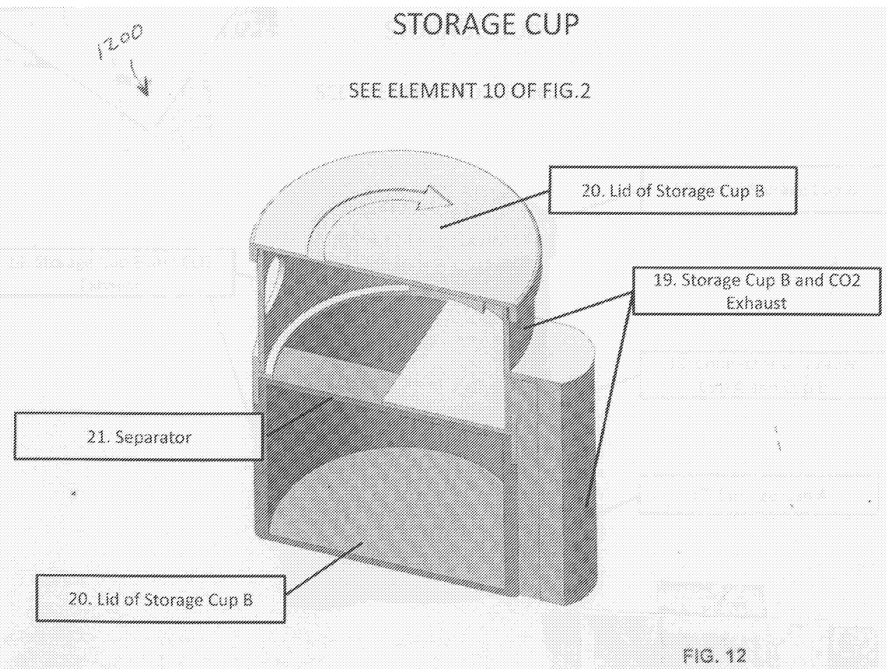

FIG. 11 is a further cut-away perspective rear view of the (CO₂) ultrasonic vibration atomizer 110. The cut-away view best illustrates certain elements of the atomizer 110 not clearly shown in FIG. 8. For example, FIG. 11 illustrates ultrasonic probe PCB 23, which activates probe 7 and separator 21, which keeps the two chemical ingredients separated until cover 20 is rotated by approximately 90 degrees.

### Method of Operation Flowchart

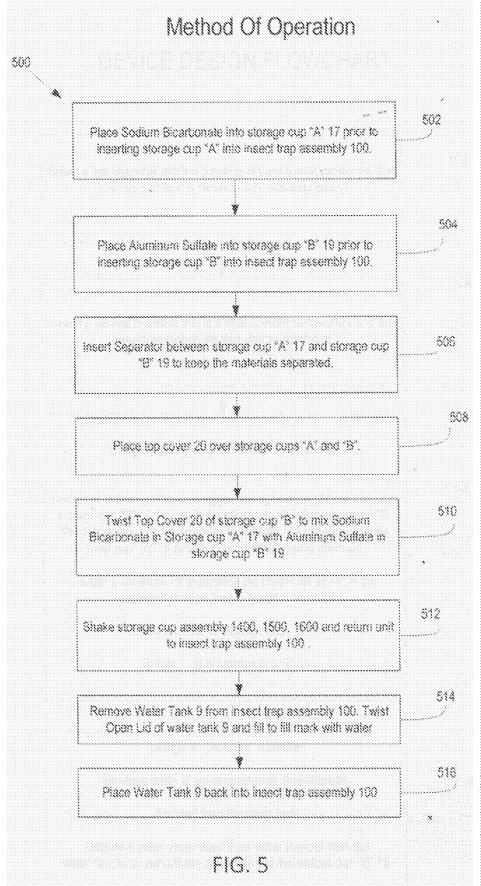

Referring now to FIG. 5 a method flowchart illustrating a method for generating an atomized vapor cloud of (CO₂) by the ultrasonic vibration atomizer 110, according to one exemplary embodiment, is shown. The steps are typically performed by a user prior to starting the insect trap assembly 100 for the first time and thereafter after each 30-day refresh.

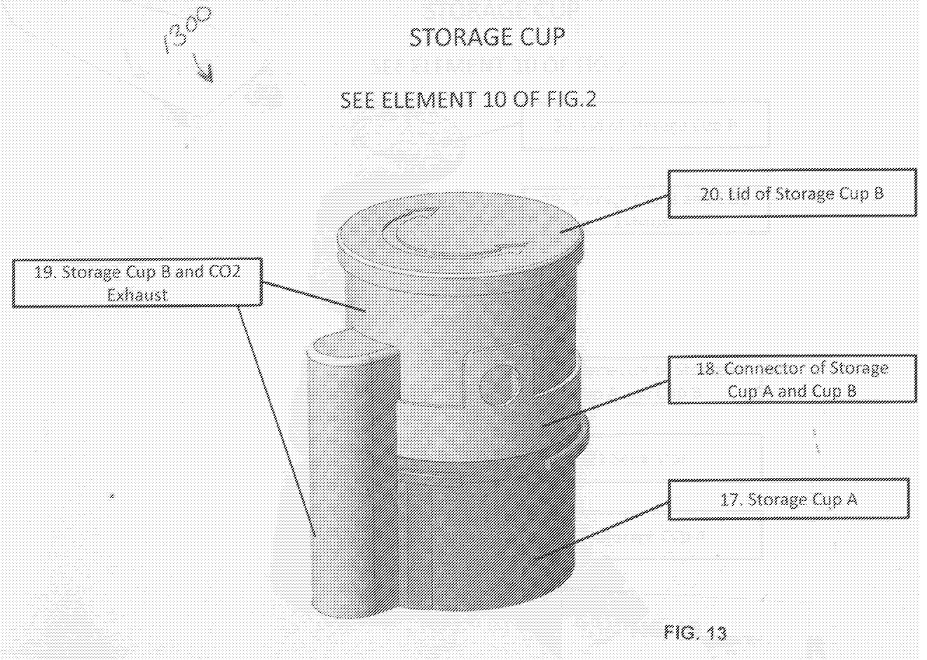

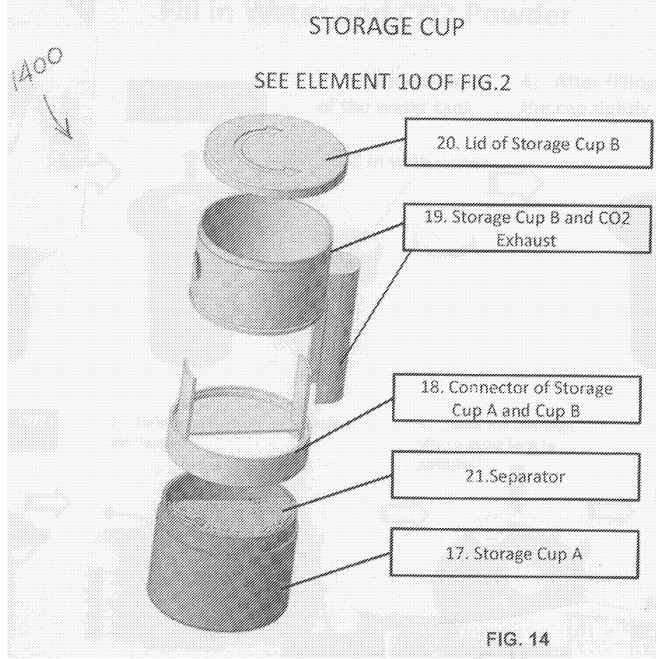

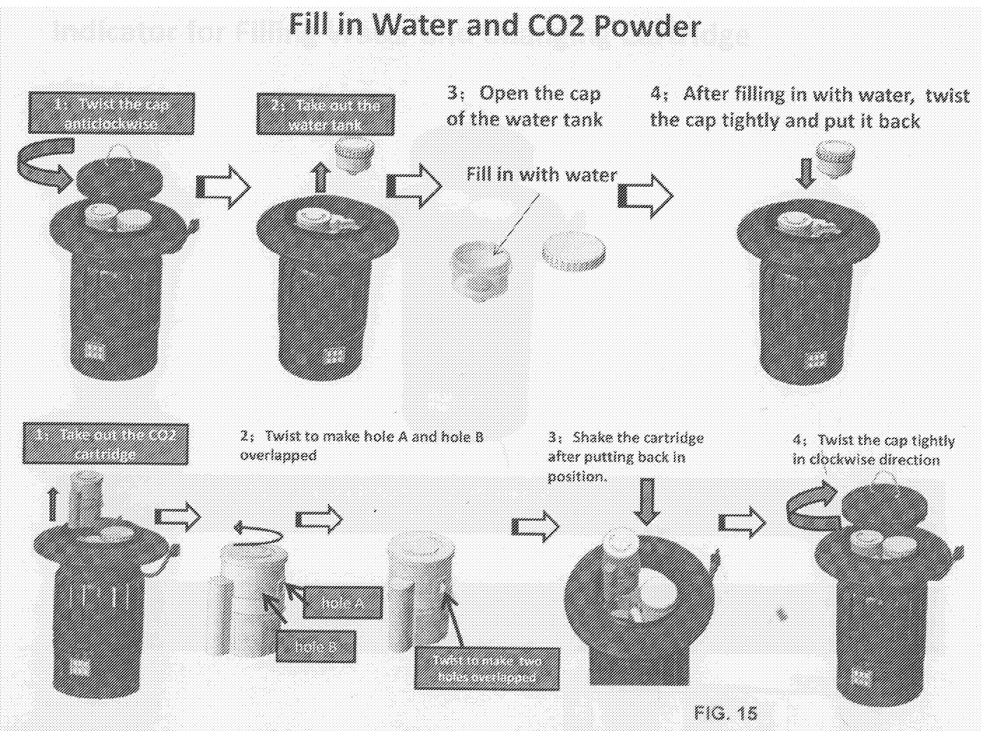

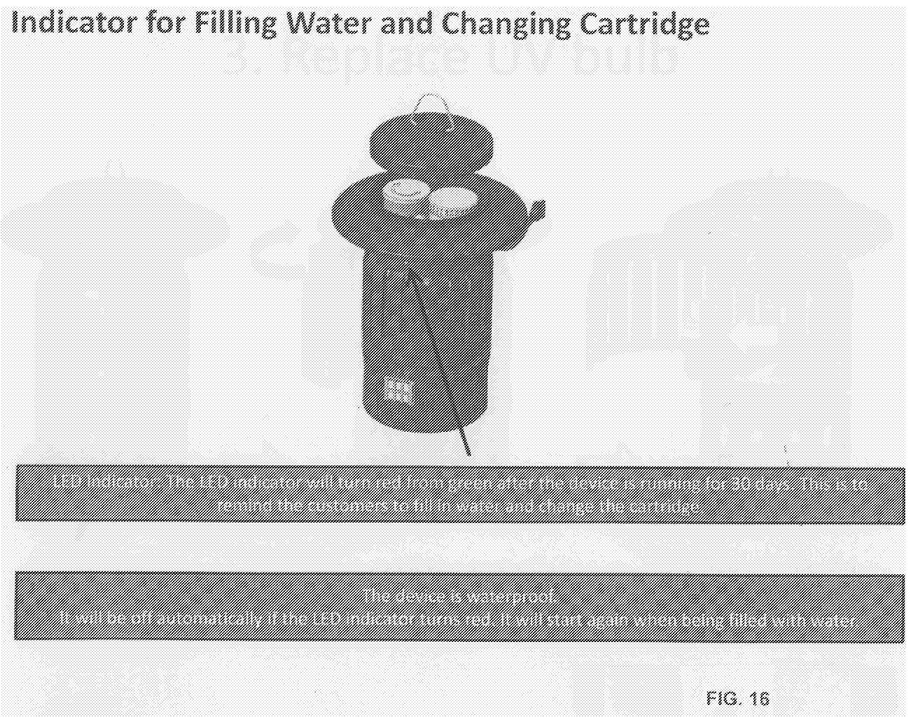

At step 502, prior to inserting storage cup “A” 17 into the storage cup assembly 1300, (See FIG. 13, 14) a first chemical, Sodium Bicarbonate, is placed into storage cup “A” 17. Sodium Bicarbonate is selected as a preferable first chemical on the basis of having the property of being comprised of solid molecules that are active and that can generate carbon dioxide (CO₂) easily as a result. Storage cup “B” 19 as one element of the storage cup assembly 1300 is configured and arranged as a combustion chamber inside of which a chemical reaction will occur between the two chemicals and atomized water to thereby generate atomized (CO₂). Preferably, the ratio of Sodium Bicarbonate to Aluminum Sulfate is 1 to 1.

At step 504, prior to inserting storage cup “B” 19, 1400 into the storage cup assembly 1500, 1600, a second chemical, Aluminum Sulfate, is placed into storage cup “B” 19, 1400. Aluminum

Sulfate is selected as a preferred second chemical by virtue of having the property of being a solid at room temperature that can readily generate carbon dioxide (CO₂) after hydrolyzation. The property of hydrolyzation may be defined as the splitting of a chemical compound into two or more compounds by reacting with water. Aluminum Sulfate satisfies this property. It is appreciated that other chemicals than those described herein may be used that meet the respective qualifications satisfied by Sodium Bicarbonate and Aluminum Sulfate, as would be known to those of skill in the art.

At step 506, separator 21 of storage cup assembly 1500, 1600), is inserted between storage cup “A” 17 and storage cup “B” 19, 1400 to keep the two chemicals, (e.g., Sodium Bicarbonate and Aluminum Sulfate) separated in their respective storage cups until such time as the user decides to mix them by mechanical action.

At step 508, the lid 20 of storage cup “B” 19 is placed over the storage cup assembly 1500, 1600) to prevent the chemical from spilling out of storage cup B.

At step 510, the lid 20 of storage cup “B” 19 may be twisted by a user to mechanically mix the Sodium Bicarbonate in storage cup “A” 17 with the Aluminum Sulfate stored in storage cup “B” 19, 1400.

At step 512, post twisting/chemical mixing action by the user, the assembled storage cup assembly is re-inserted into the insect trap assembly 100 with the two chemicals in a mixed state.

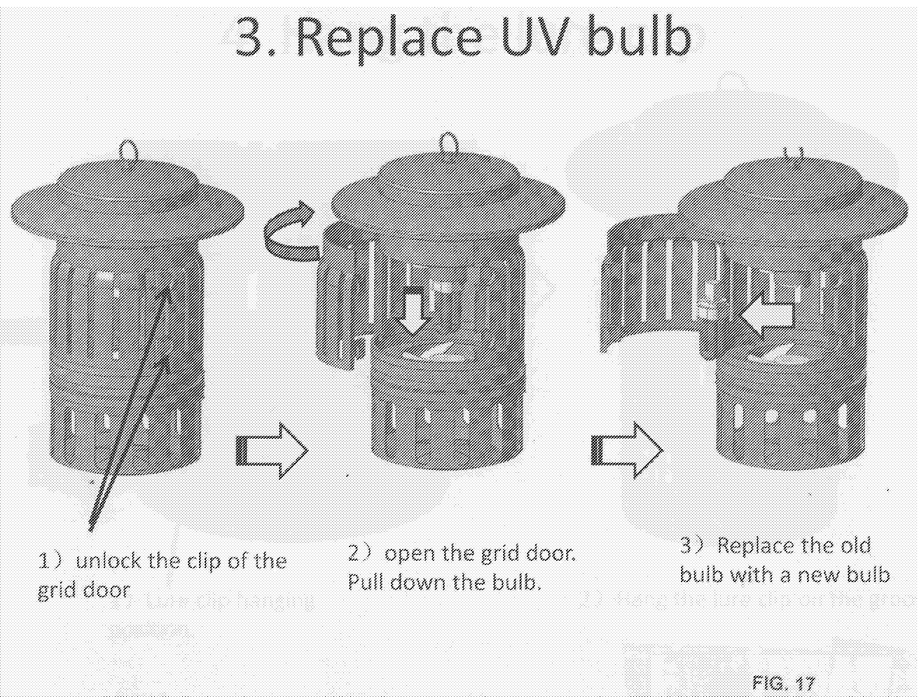

At step 514, as a further preparatory step to generating atomized carbon dioxide (CO₂), the water tank 9 (See FIGS. 2 and 3, a component of the ultrasonic atomizer 110) is temporarily removed from the ultrasonic vibration atomizer 110. The lid of the water tank may be twisted open by a user and filled with water. (See FIG. 17).

At step 516, the water tank 9 is re-inserted into the ultrasonic vibration atomizer 110. (See FIG. 17.)

At this point, the insect trap assembly 100 is ready for use and may be turned on with the turn of a single on/off switch.

### Device Design Flowchart

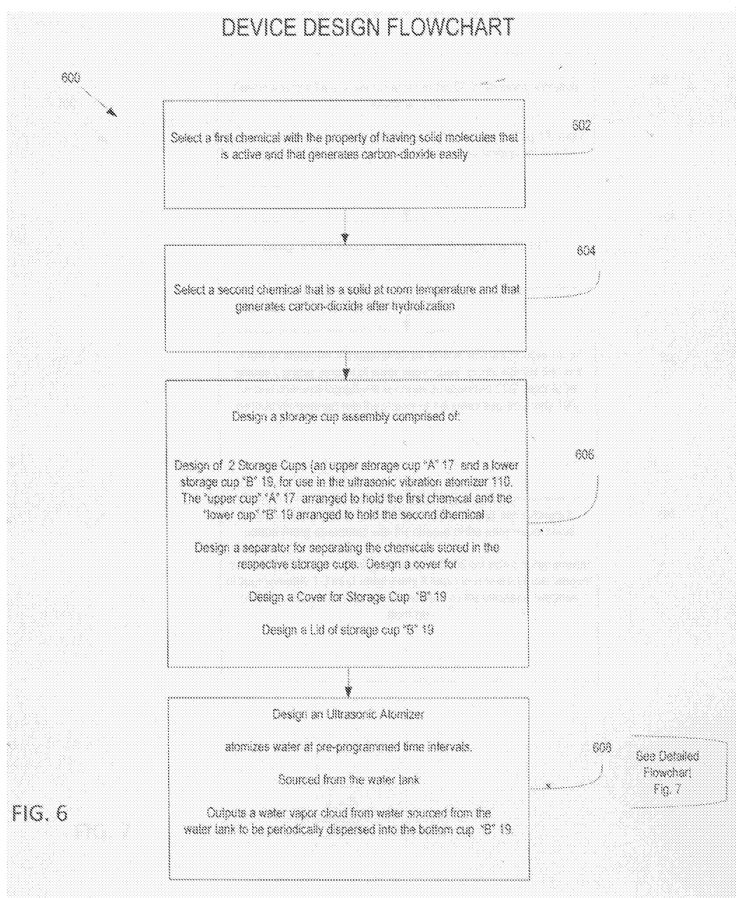

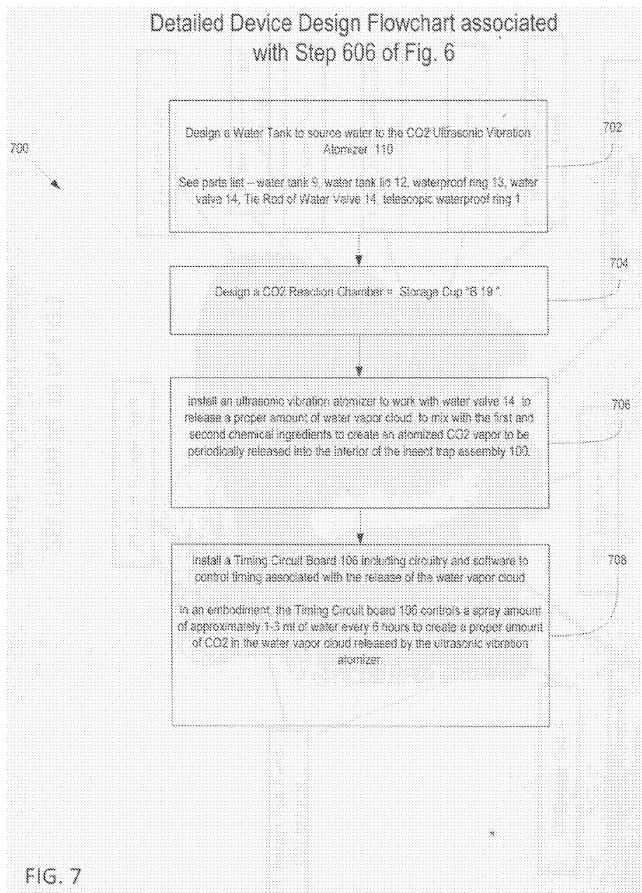

FIGS. 6 and 7 are device design flowcharts of the insect trap assembly 100 that correspond to the method flowchart of FIG. 5.

At step 602, the device designer must select a first chemical with the property of having solid molecules that are active and that generate carbon-dioxide easily. In a preferred embodiment, Sodium Bicarbonate is selected as the first chemical.

At step 604, the device designer must select a second chemical with the property of being a solid at room temperature that can readily generate carbon dioxide (CO₂) after hydrolyzation. In a preferred embodiment, Aluminum Sulfate is selected as the second chemical.

At step 606, the device designer must provide a storage cup assembly 1300 that stores the selected first and second chemicals and acts as a mixing compartment for mixing the two chemicals in coordination with a user action. The storage cup assembly 1300 includes an upper storage cup “A” 17, a lower storage cup “B” 19, a separator 21 for maintaining a separation of the two chemicals respectively stored in the upper storage cup “A” 17 and the lower storage cup “B” 19. In an embodiment, storage cup “B” 19 of storage cup assembly 1300 is shown to include a (CO₂) exhaust component 19 for dispersing the atomized vapor cloud of carbon dioxide (CO₂) out of storage cup “B,” 19. Storage cup “B” is sometimes referred to herein as the “combustion chamber.” Storage cup assembly 1300 further includes storage cup connector 18 configured and arranged to connect storage cup “A” 17 to storage cup “B” 19, and separator 21. Upper storage cup “A” 17 is configured to hold a first chemical (e.g., Sodium Bicarbonate) and lower storage cup “B” 19, 1400 is configured to hold a second chemical, (e.g., Aluminum Sulfate). Separator 21 isolates the first chemical, Sodium Bicarbonate, in the upper storage cup “A” 17 away from the second chemical, Aluminum Sulfate, in the lower storage cup “B” 19 until such time as the user decides to mix the two chemicals via a mechanical action (e.g., mechanically twisting the two cups together). The device designer must then provide a cover for upper storage cup “A” 19 and a lid for lower storage cup “B” 19.

At step 608, the device designer must design an ultrasonic vibration atomizer 110 that is configured and arranged to generate a vapor cloud of atomized carbon dioxide (CO₂) by spraying droplets of atomized water onto the combined mixture of Sodium Bicarbonate and Aluminum Sulfate. A preferred parts list to construct such an ultrasonic vibration atomizer 110 is shown below in Table I and further reproduced in FIG. 2, which is an exploded view of one embodiment of an ultrasonic vibration atomizer 110 comprised of the following parts.

### In Operation

In operation, the ultrasonic vibration atomizer 110 turns water into water vapor (e.g., a water vapor cloud) which then enters nozzle 2 and travels through connection silicone tube 29 terminating in storage cup “B” 19, 1400 to be sprayed onto the mixture of sodium bicarbonate and aluminum sulfate. The mixture of the atomized water vapor with the 2 chemical ingredients (Sodium Bicarbonate and Aluminum Sulfate) react to create the atomized vapor cloud of carbon dioxide (CO₂) which is dispersed out of storage cup “B” 19 via exhaust 19.

As the 3 materials are mixed, 6 carbon dioxides are generated:

Al₂(SO₄)₃+6NaHCO₃_>3NA₂SO₄+2AI(OH)3+6CO₂

The mixture of the chemicals and the water are controlled by a timing circuit board 106 of the ultrasonic vibration atomizer 110. The timing circuit board 106 is pre-programmed to control the overall timing of the device including:
The timing associated with creating the atomized vapor cloud of carbon dioxide CO₂) approximately once every 24 hours for a duration of about 10-30 seconds which outputs about 1-3 ml of atomized (CO₂) gas each 24-hour period.
The timing associated with spraying the atomized water into the combustion chamber (Storage Cup “B” 19) once every 6 hours such that 4 spray periods occur in a single 24-hour cycle.

The device 100 generates a consistent level of about 2000 parts per million (ppm) of atomized (CO₂) in accordance with the timing requirements described above.

Having thus described several aspects of at least one example, it is to be appreciated that various alterations, modifications, and improvements will readily occur to those skilled in the art, without departing from the spirit and scope of the invention as defined by the appended claims. Therefore, the claims are not to be limited to the specific examples depicted herein. For example, the features of one example disclosed above can be used with the features of another example. For instance, examples and embodiments disclosed herein may also be used in other contexts. Furthermore, various modifications and rearrangements of the parts may be made without departing from the spirit and scope of the underlying inventive concept. For example, the geometric configurations disclosed herein may be altered depending upon the application, as may the material selection for the components. Such alterations, modifications, and improvements are intended to be part of this disclosure and are intended to be within the scope of the examples discussed herein. Thus, the details of these components as set forth in the above-described examples, should not limit the scope of the claims.

Further, the purpose of the Abstract is to enable the U.S. Patent and Trademark Office, and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the claims of the application nor is intended to be limiting on the claims in any way.

1. An insect trap, comprising:
a housing having a body and supporting a lid;
a capture basket removably supported by the body, the capture basket being constructed to retain insects;
an ultrasonic vibration atomizer configured to periodically generate an atomized vapor cloud of CO₂ gas that acts as an insect attractant, the ultrasonic vibration atomizer comprising:
a) a storage cup assembly including a first storage cup configured to hold a first chemical, and a second storage cup configured to hold a second chemical, the second storage cup operating as a combustion chamber inside of which a chemical reaction occurs during use between the first chemical, the second chemical, and atomized water to generate atomized (CO₂);
b) the first and second storage cups being physically separated so that the first chemical and the second chemical are not in contact while being stored;
c) a water storage tank;
d) a source of mechanical vibration configured to create an ultrasonic wave directed at water held in the water storage tank; and
wherein during use the source of mechanical vibration causes the water held in the storage tank to atomize, forming atomized water vapor that reaches the combustion chamber where the first chemical and the second chemical react with the atomized water vapor to create an atomized cloud of CO₂ gas at ambient temperature as a first attractant dispersed within the housing.

2. The insect trap of claim 1, further comprising an additional insect attractant selected from the group consisting of an ultraviolet light source and a source of octenol.

3. The insect trap of claim 2, wherein the ultraviolet light source includes a light tube assembly that produces a wavelength of approximately 365 nm to 400 nm.

4. The insect trap of claim 1, further comprising a hanging member.

5. The insect trap of claim 1, wherein the first chemical is sodium bicarbonate and the second chemical is aluminum sulfate.

6. The insect trap of claim 5, wherein the ratio of sodium bicarbonate to aluminum sulfate is approximately 1 to 1.

7. The insect trap of claim 1, wherein the atomized cloud of CO₂ gas contains about 2000 parts per million (ppm) of atomized CO₂.

8. The insect trap of claim 1, filthier comprising a micro-switch configured to trigger the source of the mechanical vibration.

9. The insect trap of claim 1, wherein the source of mechanical vibration is an ultrasonic vibration slice.

10. The insect trap of claim 9, wherein the ultrasonic vibration slice operates at a high-frequency oscillation of approximately 2.4 MHz or above.
